(19) United States
(12) Patent Application Publication
(10) Pub. No.: US 2002/0136811 A1
(43) Pub. Date: Sep. 26, 2002

(54) Process for the production of reconstitutable bean products

(76) Inventors: Cheryl K. Borders, Moweaqua, IL (US); Michael J. Fleckenstein, Decatur, IL (US); Thomas Gottemoller, Mt. Zion, IL (US); Christopher A. Sandberg, Decatur, IL (US); Clifford A. Strickland, Decatur, IL (US)

Correspondence Address: STERNE, KESSLER, GOLDSTEIN & FOX PLLC, 1100 NEW YORK AVENUE, N.W., SUITE 600, WASHINGTON, DC, 20005-3934, US

(21) Appl. No.: 10/040,942

(22) Filed: Jan. 9, 2002

Related U.S. Application Data
(60) Provisional application No. 60/263,529, filed on Jan. 24, 2001.

(51) Int. Cl. A23L 1/10

(52) U.S. Cl. 426/457

(57) ABSTRACT

This invention is directed to processes for the production of edible beans, comprising the addition of an organic acid to the conditioning water, to the cooking water, or to both, which will provide a premium quality dehydrated bean. The beans of this invention are easy to prepare and will provide the same amount of finished beans as dry bag beans. The beans of the invention will have significantly fewer loose skins and free meats than currently available dehydrated beans. Further, the dehydrated beans of the invention will have a color similar to that of canned or dry bag beans.

### CROSS-REFERENCE TO RELATED APPLICATIONS

This application claims priority to U.S. Provisional Application Serial No. 60/263,529, filed Jan. 24, 2001, which application is herein incorporated by reference in its entirety.

### BACKGROUND OF THE INVENTION

1. Field of the Invention

The present invention relates generally to the art of food preparation and more particularly to improved methods for the processing and production of a dry commutated or intact, reconstitutable leguminous product and for increasing the product quality of such a product. More particularly, the invention relates to a continuous process for producing a dry, commutated, instantly reconstitutable Mexican refried bean product or an intact whole legume instantly reconstitutable for soups or side dishes. The invention is an advance in the technology for the preparation of rehydratable bean products because the method eliminates the steps of soaking and pre-cooking the beans. It also reduces the cooking time and consistently results in a dried product that is truly reconstitutable to a product with the desired characteristics of Mexican-style refried beans. In addition, other snack foods and food products may be produced. The invention also provides for a dehydrated bean product with higher nutritional quality and appearance than conventional dehydrated beans.

The scope of this invention is to provide a process and a composition for edible beans, which will provide a premium quality dehydrated bean. Current dehydrated beans on the market have many splits and broken pieces and when cooked have a significant amount of loose skins and free meats showing, as well as being darker than canned or dry bag beans. The beans of this invention are easy to prepare and provide the same yield of finished beans as do dry bag beans. The beans shall also have significantly fewer loose skins and free meats than the current dehydrated beans on the market as well as have color similar to canned or dry bag beans.

Refried beans are popular as a side dish used in Mexican-style cooking. Mexican-style foods have become one of the fastest growing segments in the American food market, both for home use and in institutions such as restaurants. Additionally, quick prep soups, meals and side dishes using other various legume and pulse products such as red beans, navy beans, pinto beans, great northern beans, kidney beans, lima beans, peas and chickpeas are becoming more and more popular. These are a great source of fiber and have a sugar profile with pro-biotic properties. Further, given today's lifestyles, meals are prepared quickly, often in 35 minutes or less. Usually, the product is prepared from scratch in a process that involves several steps in the kitchen. These steps include soaking the beans for several hours or even overnight, cooking the beans in a kettle for several more hours and mashing the cooked beans. The cook usually prepares a large batch, which is then refrigerated and refried by heating a portion of the batch to serve at each meal. Therefore, traditional dry bag beans do not meet the needs of those who prepare meals today.

Since this process is time consuming, expensive and labor intensive, canned refried beans have become popular for home use. However, canned beans are expensive and inefficient to use in the preparation of refried beans for institutional and restaurants use where large quantities of a product with consistent characteristics are desired. Even in domestic households, canned beans while providing the heat and serve convenience, are heavy to carry and difficult to dispose of, and therefore less likely to be used.

Restaurant-sized cans of beans are heavy, expensive to ship, require large storage areas, and are inconvenient to use in the preparation of large quantities of refried beans. Restaurant cooks must open many cans to prepare large servings. Cooks must be skilled in the cooking of refried beans so that a consistent, high quality product is offered to customers. Disposal of the resulting empty cans are also a problem for restaurants because, in some states, the law requires cans to be washed before disposal. In addition, leftover products create a food safety issue for the public. Therefore, dehydrated beans packed in bags are preferred for restaurants and institutional use. Not only is shipping and storage easier and less expensive, but also the preparation is simpler, usually just involving adding hot water and serving. In addition, the cost per serving for dehydrated bean products is less than that of canned beans. These factors have led to a growing demand for dehydrated refried bean products as well as other dehydrated legume products for institutional, retail, restaurant, and private volunteer organization food preparation.

Further, reconstitutable legume products, such as instant or quick prep soups, side dishes, complete meals and snack foods which incorporate legumes and pulse products may also be prepared from dehydrated products.

2. Related Art

The prior art in the commercial preparation of dehydrated bean products has provided numerous methods to form dried whole beans, bean flakes and bean powders which are reconstitutable. In general, these prior art methods consist of combinations of the following steps: soaking, blanching, parboiling, physical manipulations prior to cooking, cooking under pressure or at atmospheric pressure, post-cooking manipulations and various methods of drying the cooked product. If the desired final product is dehydrated, cooked whole beans, the prior art discloses that beans are soaked or blanched without pre-cooking physical manipulation. The prior art discloses reconstitution of dried commutated and/or powder product as occurring in a few minutes upon the addition of hot water. Reconstitution of dehydrated, cooked whole beans occurs in approximately 15-30 minutes. Both batch and continuous process are disclosed in the prior art for making dried leguminous products. Other prior art processes are variations on the above mentioned general processes.

For example, U.S. Pat. No. 4,676,990 produces a mash of legume material and forms said mash into shapes. U.S. Pat. No. 5,863,592 uses specific numbers of rollers to flake the legume product. U.S. Pat. Nos. 5,902,629 and 5,213,831 pre-cook the beans using infrared energy. U.S. Pat. No. 5,916,624 is drawn to methods of flash freezing legume products. A milling step is performed in the process of U.S. Pat. No. 5,980,971. Prior to processing, whole beans are cracked in the process of WO 98/15190.

Problems encountered by the prior art methods include large production areas to soak and cook the beans, long time periods necessary for soaking and cooking the beans, lack of adequate controls over the cooking process leading to over or under cooking, batch to batch variability and a product that does not closely resemble the conventionally prepared product. The manipulation of the beans during these processes can lead to the product being inferior due to damage incurred during the handling of the beans. In addition, the reconstitution of the dried product often takes longer than a few minutes, even when hot water is used. Moreover, powders produced by these methods tend to produce a lumpy product after rehydration.

As such, there is a continuing need in the art to provide a dried leguminous product in large quantities, in a rapid fashion, with reduced production costs in a form that is easy to ship, store, and prepare. There is also a continuing need to make a product which has consistent properties and, when rehydrated, can have a variety of textures, which instantly rehydrates with hot water. Further, when rehydrated, the product has the texture, taste, color and appearance of legumes prepared in the conventional manner.

### SUMMARY OF THE INVENTION

It is a general object of the invention to a provide a process for making dehydrated, instantly reconstitutable, leguminous food products having the characteristic flavor, texture and color of conventionally prepared legumes. The invention is drawn to a process for the production of reconstitutable legume products comprising a) conditioning the legumes by subjecting said legumes to hydration; b) cooking the legumes in a continuous advanced flight pressure vessel; c) depressurizing the cooked legumes in a hydrostatic loop; and d) dehydrating the legumes to form a reconstitutable legume product.

The invention is further drawn to a process for the production of reconstitutable legume products comprising a) continuous conditioning of the legumes by subjecting said legumes to hydration; b) cooking the legumes in a continuous advanced flight pressure vessel; c) depressurizing the cooked legumes in a chilled or hot hydrostatic loop; and d) dehydrating the legumes to form a reconstitutable legume product.

It is an object of the invention to employ a continuous advanced flight rotary drum blancher for conditioning the legumes and a continuous advanced flight pressure vessel in the preparation of reconstitutable legume products. The advanced flight mechanisms ensure that the product is advanced continuously through the conditioning and cooking steps without subjecting the legumes to handling procedures that could shear or crush the legumes.

The process further comprises washing and destoning raw legumes; carrying out the hydration in a continuous advanced flight rotary drum blancher in one, two or multiple stages; cooking the legumes in a continuous advanced flight pressure vessel; depressurizing the cooked legumes in a hydrostatic loop; and dehydrating the legumes in a one, two or multiple stage drying process to form a reconstitutable legume product. An organic acid addition may also be incorporated into the hydration/blanching step and/or the cooking step of this process.

It is a specific object of the invention to provide a method for the production of both a commutated bean product and a whole bean product. The resulting products are particularly well suited for making refried bean products, such as the type served in restaurants specializing in Mexican fare.

It is a specific object of the invention to provide a method for the production of instant or quick cook soups or stews which incorporate reconstitutable whole or intact legume products. Snack foods, which incorporate reconstitutable legume products, may also be prepared.

It is an additional object of the invention to provide a method for the production of reconstitutable legume products comprising: (a) blanching legumes in water for a period of time; (b) tempering said blanched legumes for a period of time; (c) cooking said tempered legumes in water for a period of time; and (d) dehydrating said cooked legumes to form a reconstitutable legume product; wherein an organic acid is added to the blanching water, to the cooking water, or to both.

It is a further object of the invention to provide a process for the production of reconstitutable legume products comprising: (a) blanching legumes in water for a period of time; (b) tempering said blanched legumes for a period of time; (c) cooking said tempered legumes in water for a period of time in the presence of an organic acid; and (d) dehydrating said cooked legumes to form a reconstitutable legume product.

Further objects and advantages of the present invention will be clear from the description that follows.

### BRIEF DESCRIPTION OF THE FIGURES

FIG. 1 is a diagram of the cooker/decompression loop employed in the process of preparing reconstitutable bean products.

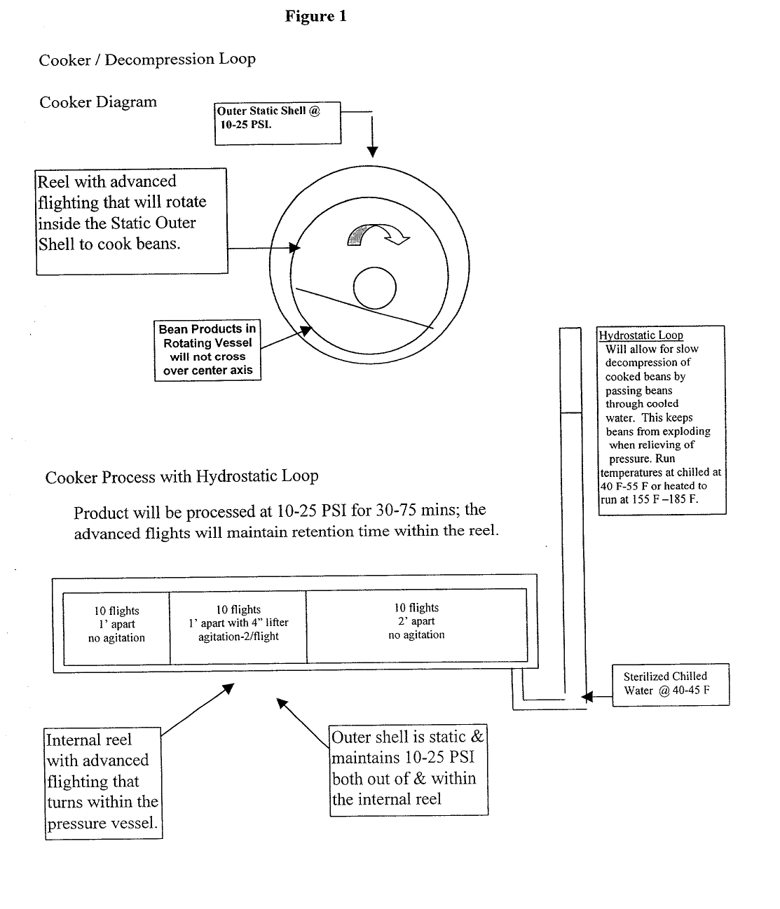

FIG. 2 is a flow chart illustrating the sequence of operations performed in the practice of the invention.

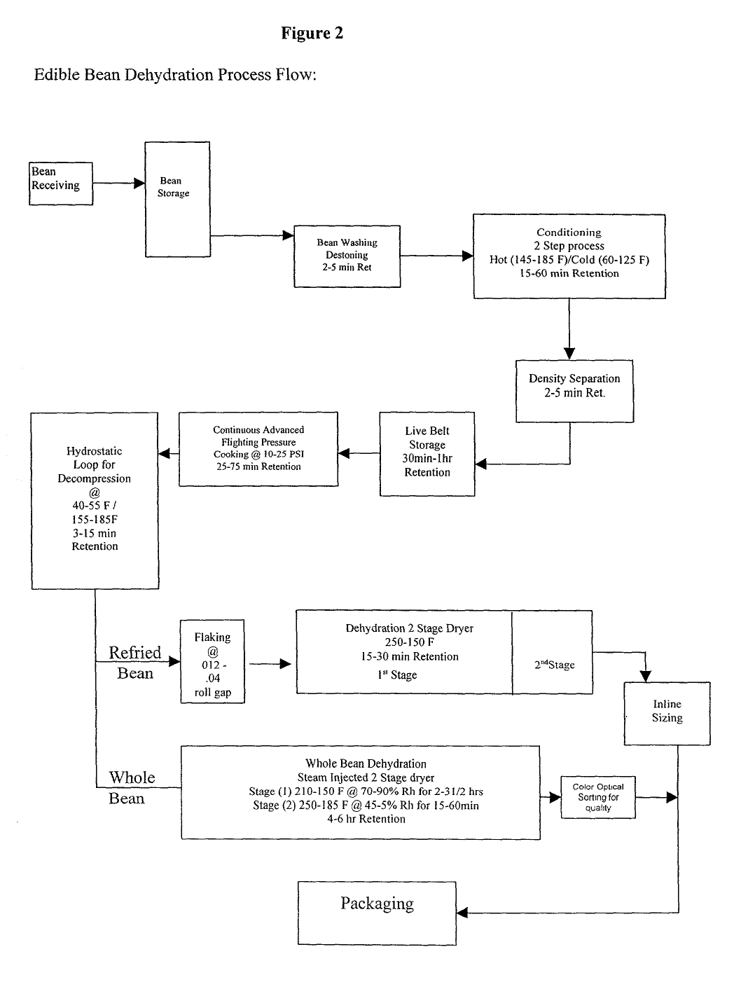

### DETAILED DESCRIPTION OF THE PREFERRED EMBODIMENTS

The process described herein may be used to produce a reconstitutable legume product for reconstitution into a ready-to-eat food product. Although typically Phaseolus species, or beans, of many varieties are used to form such a legume product, many types of legumes may be processed to form a reconstitutable food product. For example, species of green and yellow peas (Pisum) and lentils (e.g. Lens vulgaris) may be processed in addition to beans. Other legume genuses and varieties are also useful for processing. For example, Cicera arietenum (chickpeas), Glycine max (soybeans), Arachis hypogaea (peanuts) and trefoil (Lotus corniculatus) may be processed by the methods described herein. Phaseolus, or bean, varieties that may be processed include pinto beans, Great Northern beans, navy beans, red beans, black beans, dark and light red kidney beans, fava beans, green baby lima beans, pink beans, myasi beans, black eyed beans, garbanzo beans, cranberry beans, white beans, rice beans and butter beans.

Specifically, the invention is drawn to a process for the production of reconstitutable legume products comprising: (a) blanching legumes in water for a period of time; (b) tempering said blanched legumes for a period of time; (c) cooking said tempered legumes in water for a period of time in the presence of an organic acid; and (d) dehydrating said cooked legumes to form a reconstitutable legume product.

The invention is further drawn to a method for the production of reconstitutable legume products comprising: (a) blanching legumes in water for a period of time; (b) tempering said blanched legumes for a period of time; (c) cooking said tempered legumes in water for a period of time; and (d) dehydrating said cooked legumes to form a reconstitutable legume product; wherein an organic acid is added to the blanching water, to the cooking water, or to both.

The use of organic acids or their salts during the processing of dehydrated legumes and pulses enables the production of dehydrated legumes and pulses that are similar in color, texture and appearance to legumes and pulses prepared under traditional methods, such as canned beans or preparations from dry bag beans.

The legumes and pulses are harvested, cleaned, sorted, dried and put into storage until ready for further processing. At this time the legumes or pulses are resorted and washed to remove stones or loose dirt.

The legumes or pulses are then blanched at a temperature of about 50° C. to about 100° C., preferably between about 60° C. to about 85° C. The blanching takes place for a time period of about 10 minutes to about 50 minutes, preferably about 10 minutes to about 40 minutes, more preferably from about 20 minutes to about 40 minutes. The temperature of the blanch water may be varied over time to achieve the desired finished texture of the product.

An organic acid or its salt is added to the either the blanch water, the cook water, or both, at an amount ranging between about 0.1% to about 5%, preferably about 0.2% to about 3%. The organic acids that may be employed at this stage, or at the cooking stage, or at both stages, include one or more of acetic acid, citric acid, gluconic acid, gluconolactonic acid, lactic acid, ascorbic acid, malic acid their salts, and mixtures thereof.

Calcium chloride may be added to the blanch water at about 0.1% to about 1% of volume of the water, preferably about 0.2% to about 0.7%. The amount of calcium chloride added may also be based on the dry weight of the legumes or pulses, thereby adding about 0.5% to about 10% calcium chloride to the blanch water, preferably about 1% to about 5% calcium chloride. The legumes or pulses are then tempered for about 10 minutes to about 90 minutes, preferably about 20 minutes to about 45 minutes. The tempering is performed at the as-is temperature when the product removed from the blanching process. The legumes or pulses are then cooked in water at a temperature of between about 100° C. to about 125° C., preferably between about 105° C. to about 120° C., for about 10 minutes to about 60 minutes, preferably for about 10 minutes to about 45 minutes, more preferably between about 20 minutes to about 45 minutes.

The organic acids may also be added at the cooking stage in the same amounts as described supra. The organic acids, as disclosed, are preferably added at the cooking stage. As stated above, an organic acid or its salt is added to the cook water at between 0.2% and 3%. The organic acids that may be added at the cooking step include one or more of acetic acid, citric acid, gluconic acid, gluconolactonic acid, lactic acid, ascorbic acid, malic acid their salts and mixtures thereof. Sugar, glycerine and/or sorbitol are added to the cook water at an amount between about 0.5% and about 10%, based on the weight of the dry legumes or pulses. Preferably the sugar, glycerine and/or sorbitol is added at an amount between about 2% to about 10%, more preferably from about 2% to about 6%.

Salt may also be added to the cook water at between about 0.1% to about 10%, based upon the dry weight of the legumes or pulses, preferably between about 0.1% and about 5%.

The legumes or pulses are then removed from the cooker and then dried under conditions practiced in the industry, as described infra. The organic acids added at either or both of the blanching and cooking steps help to maintain the nutritional qualities of the legumes and pulses by not allowing complete denaturation of proteins and sugars encapsulated within the seed coat. Therefore, soluble product losses are minimized. The addition of the organic acid further reduces the discoloration of the finished legumes or pulses after drying and preparation, as well as prevents the skins from cracking and disassociating from the product.

The invention is further drawn to a process for the production of reconstitutable legume products comprising a) conditioning the legumes by subjecting said legumes to hydration; b) cooking the legumes in a continuous advanced flight pressure vessel; c) depressurizing the cooked legumes in a hydrostatic loop; and d) dehydrating the legumes to form a reconstitutable legume product.

The invention is further drawn to a process for the production of reconstitutable legume products comprising a) continuously conditioning the legumes by subjecting said legumes to continuous advanced flight hydration; b) cooking the legumes in a continuous advanced flight pressure vessel; c) depressurizing the cooked legumes in a chilled or hot hydrostatic loop; and d) dehydrating the legumes to form a reconstitutable legume product.

For this facet of the invention, the raw legumes are washed and destoned. This step is performed for a period of about 1 to about 10 minutes, preferably about 1 minute to about 5 minutes, most preferably from 2 minutes to 4 minutes. The legumes are immersed in water so that chaff, sticks and pod material are floated off and dirt and stones are removed through a series of riffles. Legumes of lower quality may also be removed.

Following washing and destoning, the legumes are conditioned. This can be a one, two or multiple stage process. Conditioning in hot or cold water will modify flavor and/or color. Additionally, process additives, such as calcium chloride or sodium hexmet phosphate, can be added to enhance processing. Preferably, the legumes are conditioned by hydration in a two-stage process. This process takes place in an advanced flight rotary drum blancher as a continuous process. If there are multiple stages of conditioning, the legumes are moved from one stage to the next as the legumes are moved through the rotary drum. In the process, the legumes are immersed in water during the first stage of conditioning. The legumes are then moved through the water by the advanced flighting with modified blanching temperatures.

The conditioning that follows the washing/destoning step is a preferably a two-step hydration process which takes place in a continuous advanced flight blancher. In the heated water process, the legumes are first immersed in water heated to about 100° F. to about 215° F., preferably from about 110° F. to about 210° F., most preferably from about 120° F. to about 165° F. The legumes are then subjected for a second period of time to water at a higher temperature of about 125° F. to about 225° F., preferably about 130° F. to about 210° F., most preferably from about 145° F. to about 200° F. The conditioning process can also take place in cold water which fixes product colors.

In a cold water conditioning process, the legumes are initially immersed in water at about 35° F. to about 100° F., preferably about 40° F. to about 95° F., most preferably from about 45° F. to about 85° F. The legumes are then subjected for a second period of time to water at a higher temperature of about 40° F. to about 145° F., preferably about 50° F. to about 1350° F., most preferably from about 55° F. to about 125° F.

The conditioning process takes about 5 minutes to about 3 hours, preferably about 10 minutes to about 2 hours, most preferably about 15 minutes to about 60 minutes, in the case of high temperature conditioning. With cold water conditioning, this process can take from about 30 minutes to about 4 hours, preferably about 1 hour to about 3 hours. During conditioning the legumes are hydrated and evenly blanched due to the continuous advanced flighting process.

Any remaining stones and low quality legumes are removed following conditioning by density separation methods which will remove any low quality beans and stones that were not removed during the initial washing/destoning step. Only high quality legumes remain to be formed into the reconstitutable legume product. The density separation takes about 1 to about 20 minutes, preferably about 1 to about 10 minutes, most preferably about 1 to about 3 minutes.

After the density separation, the legumes are optionally subject to live belt storage, or tempering, in order to stabilize the moisture within the legumes. After tempering, the products are conveyed through an open channel air lock into an advanced flight pressure vessel where the legumes are cooked. The tempering takes place for a period of about 10 minutes to about 3 hours, preferably about 20 minutes to about to about 2 hours, most preferably about 30 minutes to about 1 hour.

The cooking step is performed using a continuous advanced flight pressure vessel where further processing additives can be added, such as salt, organic acids or their salts and/or sugar, along with other types of processing agents. This is comprised of a rotating advanced flighted reel within a static outer shell. The flighted reel rotates within the static outer shell on a set of trunions under pressure to cook the beans from about 10 minutes to about 2 hours, preferably about 15 to about 90 minutes, most preferably about 25 to about 75 minutes at a temperature of about 200° F. to about 300° F., preferably about 230° F. to about 285° F., most preferably about 245° F. to about 255° F. The cooker comprises several sets of flights through which the legumes are continuously moved during cooking. There are three sets of ten flights, the first and third are without agitation with the middle set of flights having subtle agitation lifters within the flights rolling the product gently. An internal reel with flighting moves the legumes continuously through the cooker as it turns therefore being able to control the retention within the processing reel. As the product moves through the reel, the product continues to gain mass, therefore the last set of flights are spaced farther apart to eliminate the shearing effects of added weight.

The outer shell is static and maintains the pressure from about 10 PSI to about 25 PSI both within and outside of the internal reel. Preferably, the pressure is maintained at about 11 PSI to about 20 PSI, most preferably from about 12 PSI to about 17 PSI. Since the legumes are moved continuously through the cooker, there is no chance for the legumes to be in contact with mixing blades or to fall back upon the mixture during the final stages of cooking. This prevents the shearing and crushing of the legume product as it is moved continuously through the cooker. The cooking time can be controlled through the speed of the advanced flighting rotation through the cooker.

After cooking, the legume products are then conveyed continuously into the decompression bucket leg, or hydrostatic loop. This decompression leg maintains the pressure within the pressure vessel by providing a head of chilled or hot water. At this time, the legumes are depressurized through a water column to keep the legume intact and allowing the legume product to stabilize thermodynamically. The legumes enter the hydrostatic loop and are passed through sterilized chilled or hot water for about 1 to about 15 minutes, preferably about 1 to about 10 minutes, most preferably about 2 to about 8 minutes. The legumes rise through the water, undergoing a slow decompression. The temperature at which chilled decompression takes place is about 35° F. to about 75° F., preferably about 40° F. to about 70° F., most preferably about 45° F. to about 65° F. Hot water decompression takes place at a temperature of about 130° F. to about 215° F., preferably about 145° F. to about 200° F., most preferably at about 165° F. to about 185° F. Alternatively, the chilled decompression takes place at about 30° F. to about 55° F., preferably about 35° F. to about 45° F., more preferably from about 35° F. to about 40° F. Decompression at lower temperatures is preferred since the thermal activity is also stopped using chilled water, which aids in slow decompression. Slow decompression of the legumes is a critical factor since normal depressurization of legume products tends to puff or explode the legumes. Following the decompression, one of two routes of processing may be performed. If a whole legume product is to be produced, the product is let down to a tunnel type dryer by a soft drop spiral which bypasses the flaker rolls so as not to damage the product prior to drying. The cooked, intact legumes are then subjected to either steam injected or atomized water at low temperature in order to maintain a high relative humidity during the drying process. The drying process for whole bean products may take place in one, two or multiple stages and involves the use of unidirectional airflow up through the product at moderate temperatures with high humidity utilizing long term drying. The entire drying process can last from about 1 to about 5 hours. The drying temperature may drop throughout the range over the drying period.

If a commutated or powdered legume product is desired, the cooked legumes are subject to a form of commutating either by Fitzmill, Comitrol, Flaking, and/or blending by passing the legumes through prior to drying. Preferably one set of flaking rolls is used. The drying process for the commutated bean products may take place in one, two or multiple stages and involves the use of bidirectional airflow at moderate temperatures utilizing long term drying. The entire drying process can last from about 5 minutes to about 60 minutes. The drying temperature may drop throughout the range over the drying period.

For whole, intact legumes the drying process is preferably a two-stage process using unidirectional airflow up through the product. A first stage drying is performed at about 50% to about 95% Rh, preferably about 70% to about 90% Rh directed up through the product bed avoiding direct air from above the product for about 1 hour to about 5 hours, preferably about 1.5 hours to about to about 4 hours, most preferably about 2 hours to about 3.5 hours, while the temperature is maintained between about 125° F. to about 250° F., preferably about 150° F. to about 210° F., most preferably from about 165° F. to about 190° F. A second stage of drying is performed at temperatures from about 150° F. to about 300° F., preferably about 175° F. to about 265° F., preferably about 185° F. to about 250° F., at about 35% to about 60% Rh, preferably about 45% to about 50% Rh for about 5 minutes to about 90 minutes, preferably about 15 minutes to about 85 minutes, most preferably about 45 minutes to about 75 minutes. Following drying, the dehydrated whole legume product is subjected to color optical sorting and packaging. By use of color cameras, a computerized grid is formed and used to select intact product from the inherent broken pieces produced through material handling. The broken pieces are removed from the product stream by multiple air rejecters located above the product stream.

The legumes can be commutated prior to drying through several means, Fitzmill, Comitrol, Pumping, blending and/or flaking. Preferably, one set of flaking rolls are placed so that a gap of about 0.004 inches to about 0.25 inches, preferably about 0.010 inches to about 0.10 inches, most preferably about 0.012 inches to about 0.030 inches allows for quick preparation. The size of the flaker gap will determine the rate of reconstitution as well as the texture of the product. The texture and the reconstitution time are determined by the consumer's needs. Following flaking, the legumes are subject to an indirect steam heated two-to-three stage dryer with multiple zones using bi-directional airflow through the product bed. By using a multiple stage dryer, a higher quality product can be produced. The process is preferably a two-stage process. Drying takes place initially at temperatures time from about 200° F. to about 300° F., preferably about 215° F. to about 285° F., at a humidity level of about 0% to about 45% Rh, preferably about 10% to about 40% Rh, most preferably about 25% to about 35% Rh. The first stage is followed by a second stage drying at temperatures from about 270° F. to about 150° F., preferably about 160° F. to about 260° F. with the humidity in the second stage of about 0% to about 20% Rh, preferably about 2% to about 15% Rh, most preferably about 3% to about 10% Rh. The drying time for each stage is about 5 minutes to about 60 minutes, preferably about 10 minutes to about 50 minutes, most preferably about 15 minutes to about 30 minutes. The dehydrated legumes are then sized and/or sorted and packaged for use.

### EXAMPLE 1

Dehydrated legume products are prepared by the above processes wherein untreated thermally processed legumes are compared to ascorbic acid treated and gluconic acid treated legumes. The dehydrated legumes are reconstituted and the color of the finished product compared. These observations are shown in Table 1.

TABLE 1

| | | | | Ascorbic Acid Treated Thermal | | | Gluconic Acid Treated Thermal | | |
|---|---|---|---|---|---|---|---|---|---|
| Color Observations: | Untreated Thermal Processing | | | Processing | | | Processing | | |
| Hunter Lab 10/D65 | L | a | b | L | a | b | L | a | b |
| Reconstituted Pinto | 25.17 +/− | 7.69 +/− | 7.69 +/− | 28.23 +/− | 8.44 +/− | 8.98 +/− | 28.79 +/− | 8.30 +/− | 8.95 +/− |
| | .21 | .06 | .10 | .30 | .11 | .07 | .26 | .11 | .13 |
| Reconstituted Gt. | 38.20 +/− | 7.26 +/− | 13.74 +/− | 44.76 +/− | 7.14 +/− | 16.24 +/− | 42.80 +/− | 7.21 +/− | 15.96 +/− |
| Northern | .30 | .23 | .37 | .27 | .04 | .34 | .39 | .07 | .20 |
| Reconstituted DR | 16.72 +/− | 6.98 +/− | 4.02 +/− | 19.23 +/− | 9.27 +/− | 3.65 +/− | 18.32 +/− | 9.61 +/− | 3.20 +/− |
| Kidney | .10 | .19 | .11 | .31 | .18 | .11 | .45 | .27 | .14 |

If any additional flavorings, such as corn, soybean and sunflower oil, salt, Mexican seasoning, ranch, dehydrated onion, peppers, tomato or cheese, nutritional additives and/or color are desired, they may be added at any one of three steps. These ingredients may be added during cooking, prior to dehydration or at the time of blending and packaging.

The legumes processed according to the methods described above are economical and well adapted to quick cooking. The bean powders are instantly reconstitutable with hot water. The beans may be used as quick cook beans or in bean dips, side or main dishes. Further, they may be incorporated into instant or quick cook soups, stews, breakfast cereals and snack foods.

Having now fully described the present invention in some detail by way of illustration and example for purposes of clarity of understanding, it will be obvious to one of ordinary skill in the art that the same can be performed by modifying or changing the invention with a wide and equivalent range of conditions, formulations and other parameters thereof, and that such modifications or changes are intended to be encompassed within the scope of the appended claims.

All publications, patents and patent applications mentioned in this specification are indicative of the level of skill of those skilled in the art to which this invention pertains, and are herein incorporated by reference to the same extent as if each individual publication, patent or patent application was specifically and individually indicated to be incorporated by reference.

What is claimed is:

1) A process for the production of reconstitutable legume products comprising:
(a) conditioning legumes by subjecting said legumes to hydration;
(b) cooking said conditioned legumes in a continuous advanced flight pressure vessel;
(c) decompressing said cooked legumes in a hydrostatic loop; and
(d) dehydrating said decompressed legumes to form a reconstitutable legume product.

2) The process of claim 1, wherein conditioning is performed as a continuous process in a continuous advanced flight rotary drum blancher.

3) The process of claim 2, wherein conditioning is a two stage process.

4) The process of claim 1, wherein the conditioning is a heated conditioning.

5) The process of claim 4, wherein a first conditioning stage comprises immersing the legumes in water at a temperature of about 120° F. to about 165° F. and wherein a second conditioning stage comprises immersing the legumes in water at a temperature of about 145° F. to about 200° F.

6) The process of claim 5, wherein said first and said second conditioning stages take place for about 15 minutes to about 60 minutes.

7) The process of claim 1, wherein the conditioning is a chilled conditioning.

8) The process of claim 7, wherein a first conditioning stage comprises immersing the legumes in water at a temperature of about 45° F. to about 85° F. and wherein a second conditioning stage comprises immersing the legumes in water at a temperature of about 55° F. to about 125° F.

9) The process of claim 8, wherein said first and said second conditioning stages take place for about 1 hour to about 3 hours.

10) The process of claim 1, wherein said advanced flight pressure vessel comprises three sets of flights which move the legumes continuously through the cooker.

11) The process of claim 1, wherein cooking takes place at about 11 PSI to about 20 PSI for about 25 minutes to about 75 minutes at a temperature of about 245° F. to about 255° F.

12) The process of claim 11, wherein said cooking takes place at about 12 PSI to about 17 PSI.

13) The process of claim 1, wherein the cooked legumes are moved continuously from said advanced flight pressure cooker to a hydrostatic loop for the decompression step.

14) The process of claim 1, wherein said decompressing takes place in a heated hydrostatic loop at a temperature of about 165° F. to about 185° F. and for a time period of about 2 minutes to about 8 minutes.

15) The process of claim 1, wherein said decompressing takes place in a chilled hydrostatic loop at a temperature of about 45° F. to about 65° F. and for a time period of about 2 minutes to about 8 minutes.

16) The process of claim 1, wherein said decompressing takes place in a chilled hydrostatic loop at a temperature of about 35° F. to about 45° F. and for a time period of about 2 minutes to about 8 minutes.

17) The process of claim 1, wherein said dehydrating is a two-stage drying process.

18) The process of claim 1, wherein said reconstitutable legume product comprises whole legumes.

19) The process of claim 17, wherein a first drying stage is performed at a temperature ranging from about 150° F. to about 210° F. at about 70% to about 90% Rh for about 2 to about 3.5 hours.

20) The process of claim 17, wherein a second drying stage is performed at temperature ranging from about 185° F. to about 250° F. at about 45% to about 50% Rh for about 45 minutes to about 75 minutes.

21) The process of claim 1, wherein said reconstitutable legume product comprises commutated legumes.

22) The process of claim 17, wherein a first drying stage is performed at a temperature ranging from about 215° F. to about 285° F. for about 15 minutes to about 30 minutes at a humidity of about 25% to about 35% Rh.

23) The process of claim 17, wherein a second drying stage is performed at temperature ranging from about 160° F. to about 260° F. for about 15 minutes to about 30 minutes at a humidity of about 3% to about 10% Rh.

24) The process according to claim 1, furthers comprising a step of flaking the legumes between the steps of decompression and dehydration.

25) The process according to claim 24, wherein said flaking is performed by passing the legumes through one set of rollers.

26) The process according to claim 25, wherein the gap between the rollers is about 0.012 inches to about 0.030 inches.

27) The process of claim 1, wherein the legumes are pinto beans, black beans, Red beans, navy beans, Great Northern beans, white beans, cranberry beans, lima beans, butter beans, lentils or peas.

28) A reconstitutable legume product made by the process of claim 1.

29) A process of forming a food product comprising adding hot or cold water to the reconstitutable legume product of claim 28.

30) A process of forming a food product comprising adding hot or cold water to the reconstitutable legume product of claim 1.

31) The process of claim 1, wherein the process is a continuous process.

32) The process of claim 1, wherein an organic acid is added to said legumes at either the conditioning step, the cooking step or both.

33) The process of claim 32, wherein said organic acid is added at said cooking step.

34) The process of claim 32, wherein said organic acid is selected from the group consisting of acetic acid, citric acid, gluconic acid, gluconolactonic acid, lactic acid, ascorbic acid, malic acid, their salts and mixtures thereof.

35) The process of claim 32, wherein said organic acid is added in an amount ranging from about 0.1% to about 5%, based upon the dry weight of said legumes.

36) The process of claim 35, wherein said organic acid is added in an amount ranging from about 0.2% to about 3%.

37) A process for the production of reconstitutable legume products comprising:
(a) blanching legumes in water for a period of time;
(b) cooking said blanched legumes in water for a period of time; and
(c) dehydrating said cooked legumes to form a reconstitutable legume product;
(d) wherein an organic acid is added to the blanching water, to the cooking water, or to both.

38) The process of claim 37, wherein said organic acid is selected from the group consisting of acetic acid, citric acid, gluconic acid, gluconolactonic acid, lactic acid, ascorbic acid, malic acid, their salts and mixtures thereof.

39) The process of claim 37, wherein said organic acid is added to the blanching water.

40) The process of claim 37, wherein said organic acid is added to the cooking water.

41) The process of claim 37, wherein said organic acid is added to both the blanching water and the cooking water.

42) The process of claim 37, wherein said organic acid is added in an amount ranging from about 0.1% to about 5%, based upon the dry weight of said legumes.

43) The process of claim 42, wherein said organic acid is added in an amount ranging from about 0.2% to about 3%.

44) The process of claim 37, wherein calcium chloride is added to the blanching water.

45) The process of claim 44, wherein the calcium chloride is added to the blanching water in an amount ranging from about 0.5% to about 10%, based upon the dry weight of said legumes.

46) The process of claim 45, wherein said amount of calcium chloride ranges from about 1% to about 5%.

47) The process of claim 37, wherein said blanching takes place at a temperature of about 50° C. to about 100° C. for about 10 minutes to about 40 minutes.

48) The process of claim 47, wherein said blanching takes place at a temperature of about 60° C. to about 85° C. for about 20 minutes to about 30 minutes.

49) The process of claim 37, wherein said legumes are tempered after said blanching for about 10 minutes to about 90 minutes.

50) The process of claim 49, wherein said tempering takes place for about 20 minutes to about 45 minutes.

51) The process of claim 37, wherein said cooking takes place at a temperature of about 100° C. to about 125° C. for about 10 minutes to about 60 minutes.

52) The process of claim 51, wherein said cooking takes place at a temperature of about 105° C. to about 120° C. for about 20 minutes to about 45 minutes.

53) The process of claim 37, wherein salt is added to the cooking water in an amount ranging from about 0.1% to about 10%, based upon the dry weight of said legumes.

54) The process of claim 53, wherein said salt is added in an amount ranging from about 0.1% to about 5%.

55) The process of claim 37, wherein sugar, glycerine or sorbitol is added to the cooking water in an amount ranging from about 0.5% to about 10%, based upon the dry weight of said legumes.

56) The process of claim 55, wherein said sugar, glycerine or sorbitol is added in an amount ranging from about 2% to about 10%.

57) The process of claim 56, wherein said sugar, glycerine or sorbitol is added in an amount ranging from about 2% to about 6%.

58) The process of claim 37, wherein said legumes selected from the group consisting of pinto beans, black beans, red beans, navy beans, Great Northern beans, white beans, cranberry beans, lima beans, butter beans, lentils and peas.

59) A reconstitutable legume product made by the process of claim 37.

60) A process of forming a food product comprising adding hot or cold water to the reconstitutable legume product of claim 59.

61) The process according to claim 37 comprising:
(a) blanching legumes in water for a period of time at a temperature of about 60° C. to about 85° C. for about 20 minutes to about 30 minutes;
(b) cooking said legumes in water for a period of time at a temperature of about 105° C. to about 120° C. for about 20 minutes to about 35 minutes; and
(c) dehydrating said cooked legumes to form a reconstitutable legume product; wherein said process further comprises tempering said legumes for a period of time of about 20 minutes to about 45 minutes, after said blanching and before said cooking, and wherein an organic acid selected from the group consisting of acetic acid, citric acid, gluconic acid, gluconolactonic acid, lactic acid, ascorbic acid, malic acid, their salts and mixtures thereof, is added to the cooking water in an amount ranging from about 0.2% to about 3%.
